(19) United States
(12) Patent Application Publication
(10) Pub. No.: US 2009/0044931 A1
(43) Pub. Date: Feb. 19, 2009

(54) Heat Exchanger for Hot Air Generator and Boiler

(76) Inventor: Angelo Rigamonti, Pessano Con Bornago (IT)

Correspondence Address: WENDEROTH, LIND & PONACK, L.L.P., 2033 K STREET N. W., SUITE 800, WASHINGTON, DC, 20006-1021, US

(21) Appl. No.: 12/223,922

(22) PCT Filed: Oct. 11, 2006
(86) PCT No.: PCT/EP2006/067252

§ 371 Date: Aug. 13, 2008

(30) Foreign Application Priority Data
Feb. 15, 2006 (IT) MI2006QA000274

(51) Int. Cl. F28D 1/02; B23P 15/26

(52) U.S. Cl. 165/153; 29/890.043

(57) ABSTRACT

There is described a heat exchanger (1) comprised of at least one exchanger module (13), comprising a combustion chamber (10) for the generation of an exchange fluid, a slotted wall (11) for the passage of the exchange fluid and an expulsion chamber (12) for the exchange fluid provided with a discharge flue (33). Said exchanger module (13) is formed by a pair of basic elements (14), each of which contributes to form a part of said combustion chamber (10), a part of said slotted wall (11) and a part of said expulsion chamber (12). The basic elements (14) are reciprocally connected in facing position so as to form a single block. The present invention allows to facilitate the assembly operations for a heat exchanger, to obtain modular exchangers and to reduce the structural elements of the exchangers.

The present invention relates to a heat generator.

Heat generators are devices that are normally used in industrial or domestic systems to modify the temperature or the state of fluids, e.g. air or water. The principle they are based on is the transmission by conduction of heat through a wall or a membrane, so that two fluids tend to reduce the mutual temperature difference by generating a thermal flow that tends to warm the colder fluid and to cool the warmer fluid. The temperatures obtained at the end of such process vary depending on the physical and chemical characteristics of the fluids (air, water or others) and of the wall or membrane (having high or low thermal conductivity), on the geometry of the membrane surface (a larger slotted wall generally leads to a greater amount of heat exchanged) and on the flow characteristics (forced or natural convection, presence of turbulences).

In this way, the temperature of a fluid (“working fluid”) may be modified by forcing the heat exchange with another fluid (“exchange fluid”), a large amount of which is available at a temperature suitable to bring the working fluid to the requested temperature. When the heat exchange is over, the working fluid reaches the requested temperature, whereas the exhausted exchange fluid no longer allows the requested heat exchange and must therefore be expelled.

For example, if the working fluid needs to be heated, a heat exchange with fumes obtained by combustion from a burner may be carried out. To put such a process into practice, it is possible to use a heat generator comprised of:
a combustion chamber to generate high temperature fumes;
a tube bundle for the thermal exchange between the fumes and the working fluid;
a collection chamber for the exhausted fumes;
connectors between the combustion chamber and the tube bundle and between the latter and the fume collection chamber;
a discharge flue in connection with the fume collection chamber.

More generally, a generic heat generator comprises:
a combustion chamber;
a slotted wall between the exchange fluid and the working fluid;
an expulsion chamber for the exhausted exchange fluid;
connector elements between the various components.

Even if the physical principle the heat generator technique is based on is very simple, there occurs a great difficulty in assembling the generator, because the constituent elements and the connector elements are numerous and different; their construction requires the use of a lot of machinery and equipment and of skilled labour.

Moreover, the need to achieve high efficiency in terms of exchanged heat in relation to the size of the heat generator leads to force winding paths for the exchange fluid, by inserting devices adapted to obtain a turbulent flow, which further increase the complexity of the heat generators.

Finally, because of the heat generator assembling complexity, it is rather difficult to modify the generators once these have already been constructed.

It is the object of the present invention to obtain a heat generator allowing to overcome the above-said construction problems.

According to the invention such an object is achieved by a heat generator as defined in claim 1.

The exchange fluid is formed in the combustion chamber, it enters the slotted wall and it passes in the expulsion chamber, from which it exits through the discharge flue.

The construction process of a generator according to the invention may comprise three processing steps:
a construction step for said basic elements from sheet elements;
a construction step for said generator modules from said basic elements;
an assembling step for said heat generator from said generator modules.

Said construction step for said basic elements may comprise the mechanical deformation of sheet elements, through processes such as drawing, and the removal of parts of such a sheet.

Said construction step for said generator modules may comprise the connection of basic elements, e.g. obtained by laser welding, and the removal of parts of such basic elements.

Said assembling step for generator according to the invention may comprise the connection of several generator modules, e.g. obtained by laser welding, so that such generator modules are connected in a cascade. Finally, to said generator there is applied a burner that generates an exchange fluid by burning within the combustion chamber.

It may be noted that the construction of a generator is particularly simple. Moreover, the addition and the removal of further generator modules is facilitated, rendering the modification of size, features and potential of said generator easy.

These and other features of the present invention will become more apparent from the following detailed description of an embodiment thereof, which is illustrated by no way of limitation in the accompanying drawings, in which:

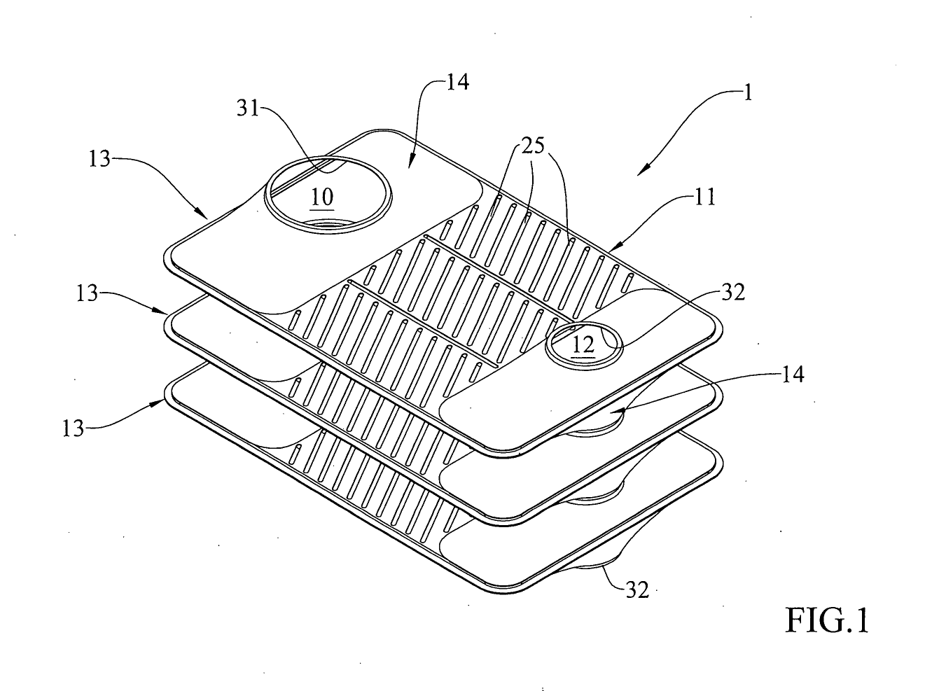

FIG. 1 shows a perspective view of a heat generator according to an embodiment of the present invention;

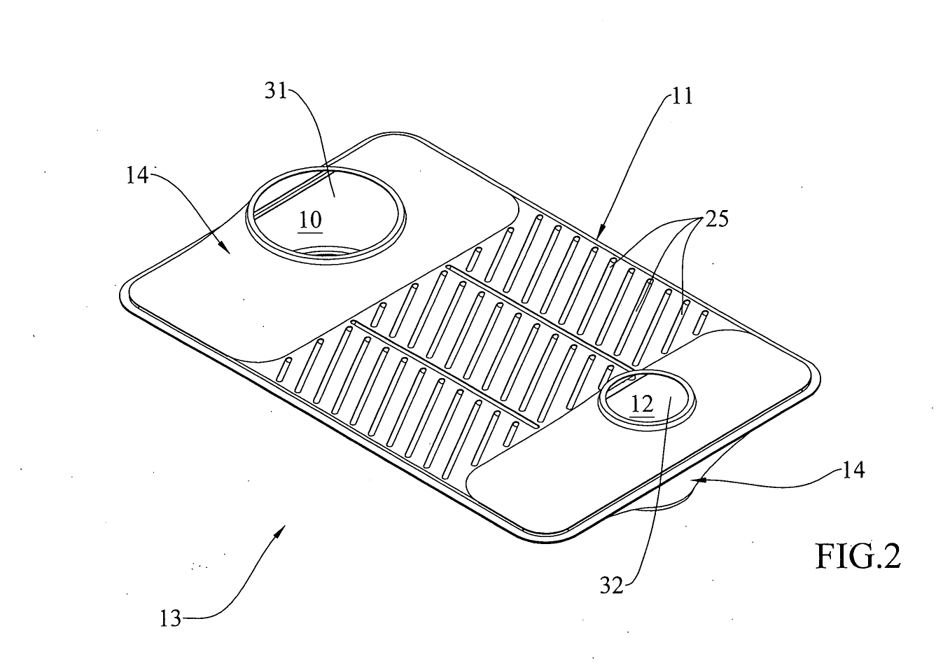

FIG. 2 shows a perspective view of a generator module constituting the embodiment of FIG. 1;

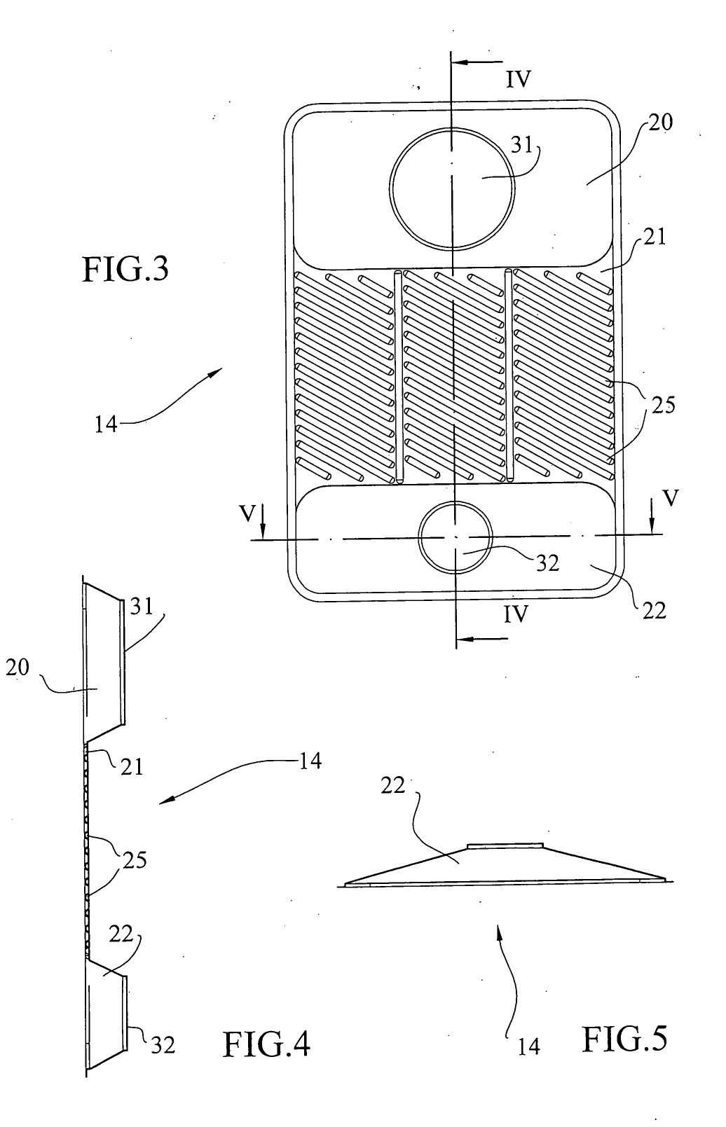

FIG. 3 shows a plan view of a basic element of a generator module according to the embodiment of FIG. 2;

FIG. 4 shows a front section along line IV-IV of the basic element of FIG. 3;

FIG. 5 shows a side section along line V-V of the basic element of FIG. 3;

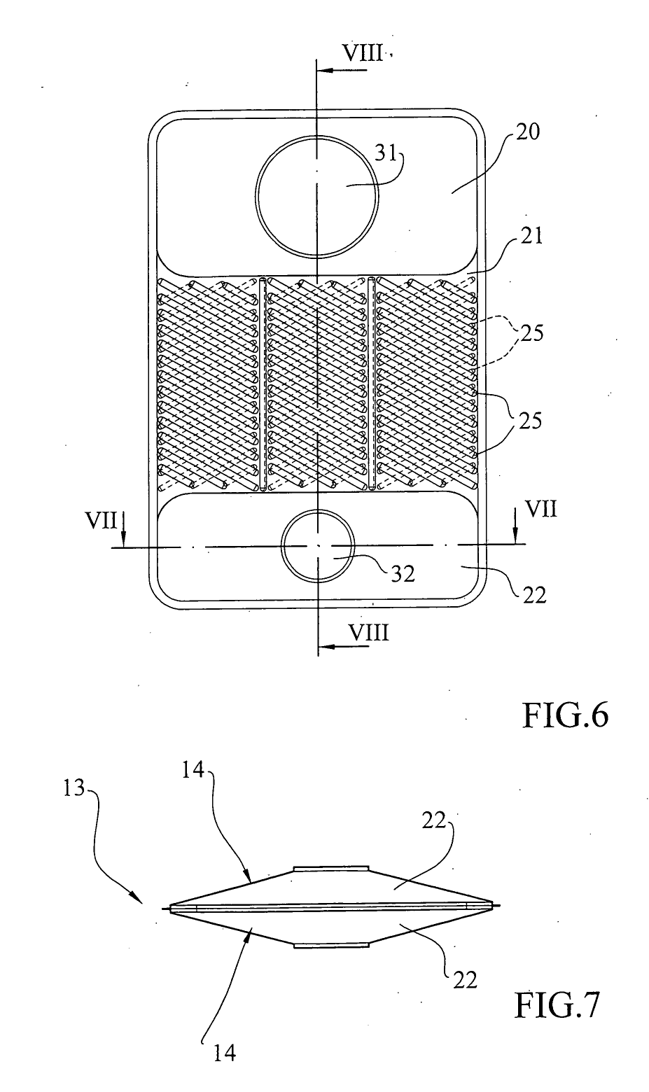

FIG. 6 shows a top view of a generator module according to the embodiment of FIG. 2;

FIG. 7 shows a side section along line VII-VII of the generator module of FIG. 6;

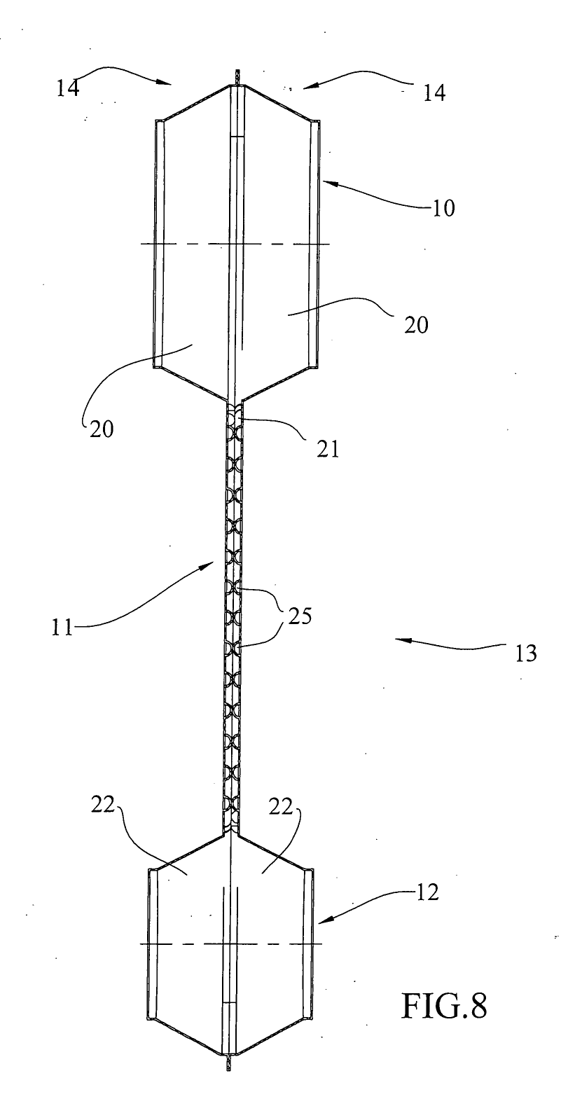

FIG. 8 shows a front section along line VIII-VIII of the generator module of FIG. 6;

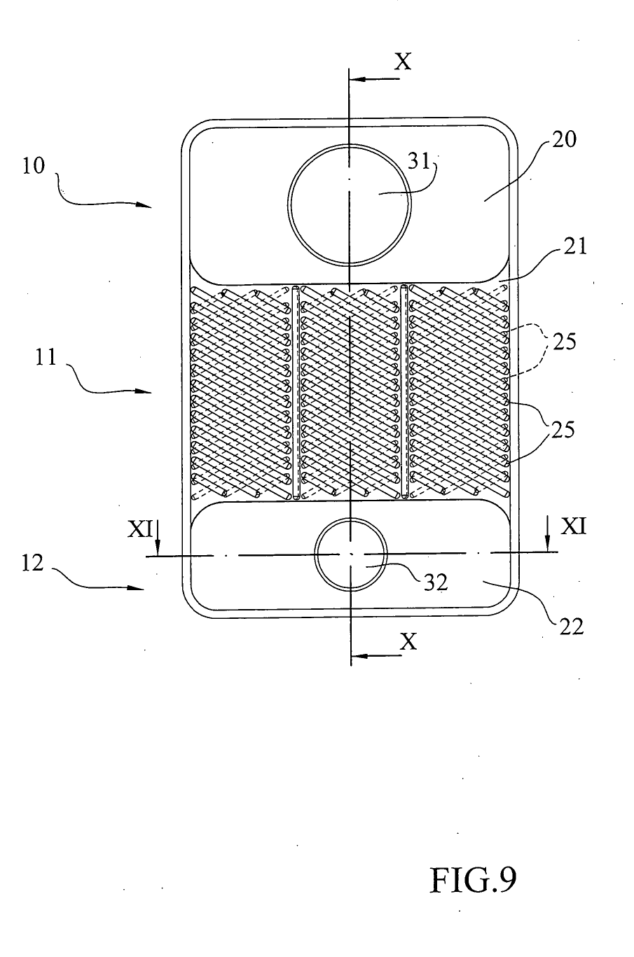

FIG. 9 shows a top view of the generator module of FIG. 1;

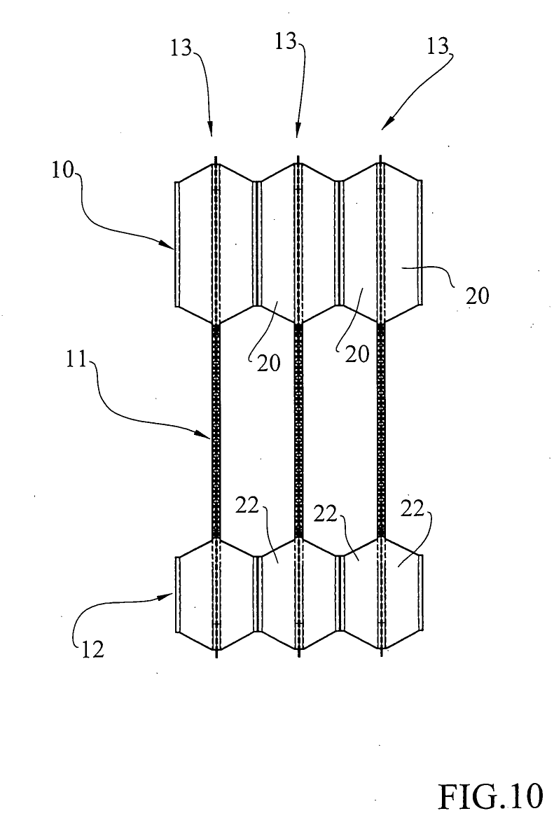

FIG. 10 shows a front section along line X-X of the composite generator of FIG. 9;

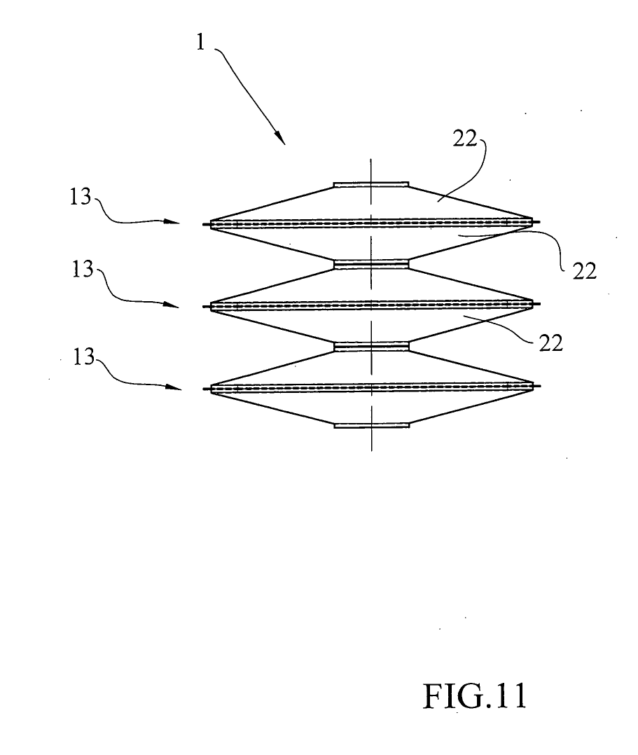

FIG. 11 shows a side section along line XI-XI of the generator of FIG. 9;

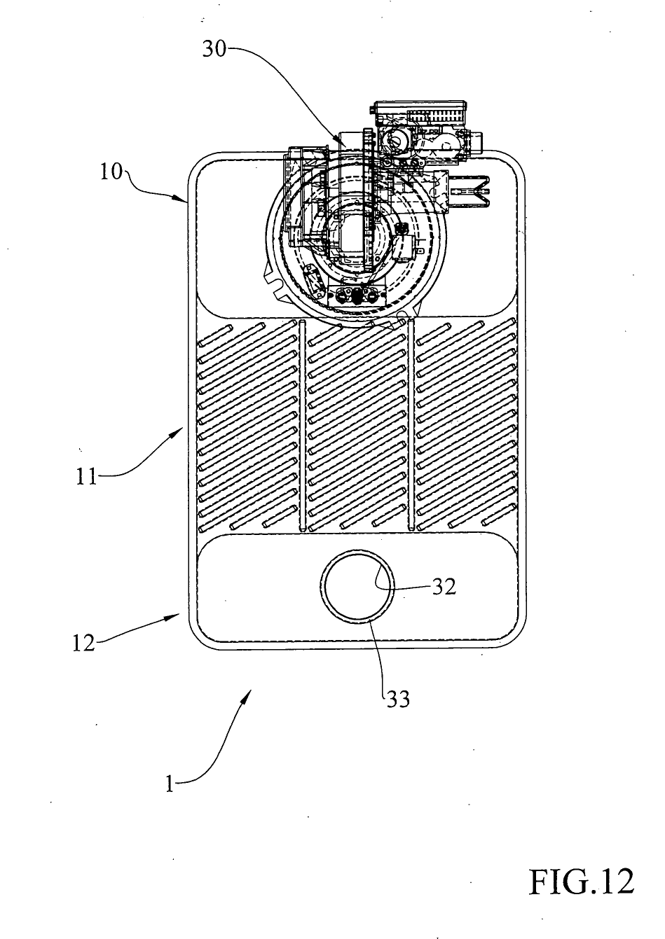

FIG. 12 shows a plan view of the generator of FIG. 1 and highlights the connection with a burner;

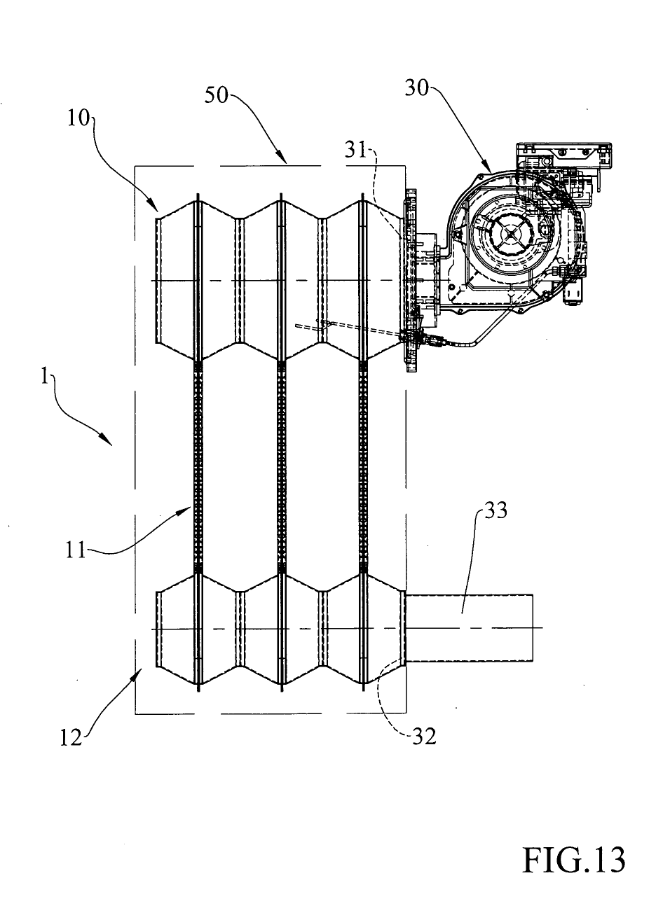

FIG. 13 shows a front view of the generator of FIG. 12 and highlights a sealed housing allowing the heating of a liquid.

With reference to FIG. 1, a heat generator 1, comprised of three reciprocally connected generator modules 13, may be observed, where each module 13 (FIG. 2) is subdivided in a combustion chamber 10, a slotted wall 11 and an expulsion chamber 12. Said generator module is comprised of two basic elements 14 reciprocally attached in facing position.

One of said basic elements 14, made of stainless steel, is shown in FIGS. 3-5. There may be recognized:
a surface 20, which contributes to combustion chamber 10 where the exchange fluid is generated, having an aperture 31 which is normally shut;
a surface 21, which contributes to form half of the slotted wall 11, having a plurality of slots 25;
a surface 22, which contributes to form said expulsion chamber 12 for the exhausted exchange fluid, having an aperture 32, which is normally shut.

With reference to FIGS. 6-8, it is possible to observe a generator module 13 formed by two basic elements 14. From the comparison of FIG. 4 with FIG. 8 and the comparison of FIG. 7 with FIG. 5, it is possible to understand the construction mechanism of said generator module 13 from two basic elements 14, which are reciprocally connected by laser welding, and to appreciate the simplicity of the obtainment of the chambers 10 and 12 and slotted walls 11 are obtained from surfaces 20, 22 and 21. It may also be noted that the construction does not need further connector elements between the parts of said exchanger module 13, which is therefore ready for use.

With reference to FIGS. 9-11, it is possible to observe said heat exchanger 1 formed by three generator modules 13. From the comparison of FIG. 11 with FIG. 7 and the comparison of FIG. 8 with FIG. 10, it is possible to understand the assembling mechanism of a heat exchanger 1 from generator modules 13, which are reciprocally connected by laser welding. Such an assembly provides the opening of communication apertures 31 and 32 in the coupled basic elements 14.

With reference to FIGS. 12-13, it is possible to observe the same heat generator 1 formed by three modular elements 13, in which a burner 30 (not shown in FIGS. 1-11) is highlighted, which is connected to combustion chamber 10 through an aperture 31 that is appropriately opened, and a discharge flue 33 connected to an expulsion chamber 12 at an aperture 32 that is also appropriately opened.

If said heat generator is used to heat a liquid, then it may be inserted within an appropriate sealed housing 50 provided with an inlet and an outlet for the liquid.

1-11. (canceled)

12. A heat generator (1) comprised of at least one generator module (13) comprising a larger-size combustion chamber (10) provided with an aperture (31) for connection of a burner (30) for the generation of a heat exchange fluid inside the combustion chamber (10), a smaller-size expulsion chamber (12) provided with an aperture (32) for connection of a discharge flue (33) and an internally slotted wall (11) for the passage of the exchange fluid from the combustion chamber (10) to the expulsion chamber (12), the combustion chamber (10) being arranged in top position and the expulsion chamber (12) being arranged in bottom position to cause the exchange fluid to run along the internally slotted wall (11) in a descending direction, wherein said exchanger module (13) is formed by a pair of basic elements (14), each of which forms a part of said combustion chamber (10), a part of said internally slotted wall (11) and a part of said expulsion chamber (12), such basic elements (14) being reciprocally connected in facing position so as to form a single block.

13. A heat generator according to claim 12, characterised in that said internally slotted wall (11) provides for winding paths for the exchange fluid, constructed by tilted and crossed slots intended to increase the flow vorticity.

14. A heat generator according to claim 12, characterised in that it is made of stainless steel.

15. A heat generator according to claim 12, characterised in that it is inserted within a sealed housing (50), in order to allow the heating of a liquid contained in said sealed housing.

16. A manufacturing process for a heat generator according to claim 12, characterised in that it comprises a first step for said basic elements (14) from sheet elements, a second step for connecting said basic elements (14) to form generator modules (13), and a third step for assembling said generator modules (13) to form a heat generator (1).

17. A process according to claim 16, characterised in that said first step comprises the mechanical deformation of stainless steel sheet elements.

18. A process according to claim 16, characterised in that said second step provides for laser welding of said basic elements (14).

19. A process according to claim 16, characterised in that said third step provides for laser welding of said generator modules (13).

20. A process according to claim 16, characterised in that said first step provide for the opening of an aperture (31) for the application of a burner (30) and of a further aperture (32) for the application of a discharge flue (33).

21. A heat generator according to claim 13, characterised in that it is made of stainless steel.

22. A heat generator according to claim 13, characterised in that it is inserted within a sealed housing (50), in order to allow the heating of a liquid contained in said sealed housing.

23. A heat generator according to claim 14, characterised in that it is inserted within a sealed housing (50), in order to allow the heating of a liquid contained in said sealed housing.

24. A manufacturing process for a heat generator according to claim 13, characterised in that it comprises a first step for said basic elements (14) from sheet elements, a second step for connecting said basic elements (14) to form generator modules (13), and a third step for assembling said generator modules (13) to form a heat generator (1).

25. A manufacturing process for a heat generator according to claim 14, characterised in that it comprises a first step for said basic elements (14) from sheet elements, a second step for connecting said basic elements (14) to form generator modules (13), and a third step for assembling said generator modules (13) to form a heat generator (1).

26. A manufacturing process for a heat generator according to claim 15, characterised in that it comprises a first step for said basic elements (14) from sheet elements, a second step for connecting said basic elements (14) to form generator modules (13), and a third step for assembling said generator modules (13) to form a heat generator (1).

27. A process according to claim 17, characterised in that said second step provides for laser welding of said basic elements (14).

28. A process according to claim 17, characterised in that said third step provides for laser welding of said generator modules (13).

29. A process according to claim 18, characterised in that said third step provides for laser welding of said generator modules (13).

30. A process according to claim 17, characterised in that said first step provide for the opening of an aperture (31) for the application of a burner (30) and of a further aperture (32) for the application of a discharge flue (33).

31. A process according to claim 18, characterised in that said first step provide for the opening of an aperture (31) for the application of a burner (30) and of a further aperture (32) for the application of a discharge flue (33).
